(19) United States
(12) Patent Application Publication
(10) Pub. No.: US 2008/0100224 A1
(43) Pub. Date: May 1, 2008

(54) System on a chip with backlight controller

(76) Inventors: Matthew D. Felder, Austin, TX (US); Matthew Ross Williamson, Austin, TX (US); Jingyu Hu, Austin, TX (US); Jamie Joseph Happ, Austin, TX (US)

Correspondence Address: GARLICK HARRISON & MARKISON, P.O. BOX 160727, AUSTIN, TX, 78716-0727, US

(21) Appl. No.: 11/799,363

(22) Filed: May 1, 2007

Related U.S. Application Data
(60) Provisional application No. 60/855,533, filed on Oct. 31, 2006.

(51) Int. Cl. H05B 37/02

(52) U.S. Cl. 315/151; 315/307

(57) ABSTRACT

A backlight control module includes a gain module, a variable voltage reference, a comparator, and a pulse width modulator. The gain module is coupled to amplify a representation of LED current to produce an amplified current sense signal. The variable voltage reference source is coupled to produce a reference voltage based on the backlight setting to produce a representation of the backlight setting. The comparator is coupled to compare the reference voltage with the amplified current sense signal to produce the comparison signal. The pulse width modulator is coupled to produce a pulse width modulated (PWM) signal as the brightness control signal based on the comparison signal, wherein the brightness control signal is provided to an off-chip variable supply voltage source that provides power to the off-chip LED.

### CROSS REFERENCE TO RELATED PATENTS

NOT APPLICABLE

### STATEMENT REGARDING FEDERALLY SPONSORED RESEARCH OR DEVELOPMENT

NOT APPLICABLE

### INCORPORATION-BY-REFERENCE OF MATERIAL SUBMITTED ON A COMPACT DISC

NOT APPLICABLE

### BACKGROUND OF THE INVENTION

1. Technical Field of the Invention

This invention relates generally to mixed signal integrated circuits and more particularly to backlight controlling by a system on a chip.

2. Description of Related Art

In general, a system on a chip (SOC) integrates multiple independent circuits, which are typically available as individual integrated circuits, on to a single integrated circuit. For example, an audio processing SOC combines a processing core (e.g., microprocessor and/or digital signal processor, instruction cache, and data cache), an audio codec (e.g., digitization of analog audio input signals and converting digitized audio signals into analog output signals), a high speed serial interface (e.g., universal serial bus (USB) interface), a display interface, and an external memory interface.

In many applications of an audio processing SOC, the display interface is coupled to a liquid crystal display (LCD), which is illuminated via a backlight light emitting diode LED). The level of brightness of the LED is controlled by a backlight controller. In one known embodiment, the backlight controller is off-chip of the SOC, where the SOC provides the off-chip backlight controller digital or analog control signals regarding a desired brightness. The off-chip backlight controller processes the digital or analog control signals to regulate a voltage (or current) applied to the LED thereby regulating the brightness of the LED. While this technique provides backlight control, it requires an additional integrated circuit.

In another known embodiment, the backlight control circuit is implemented via discrete components where the SOC provided a switching control signal to the discrete components. While this technique eliminates the need for an additional integrated circuit, it provides an open loop control mechanism, which provides a loose control over the brightness of the LED. Since the LED is a significant power sink of a battery powered device incorporating the SOC, tight control of the LED is desired.

Therefore, a need exists for an SOC that includes an on-chip backlight controller and applications thereof.

### BRIEF DESCRIPTION OF THE SEVERAL VIEWS OF THE DRAWING(S)

FIG. 1 is a schematic block diagram of a system on a chip (SOC) in accordance with the present invention;

FIG. 2 is a schematic block diagram of an embodiment of a backlight control module coupled to an off-chip variable supply voltage source in accordance with the present invention;

FIG. 3 is a logic diagram of a method for controlling backlighting in accordance with the present invention;

FIG. 4 is a logic diagram of another method for controlling backlighting in accordance with the present invention;

FIG. 5 is a schematic block diagram of another embodiment of a backlight control module coupled to an off-chip variable supply voltage source in accordance with the present invention;

FIG. 6 is a schematic block diagram of another embodiment of a backlight control module coupled to an off-chip variable supply voltage source in accordance with the present invention;

FIG. 7 is a schematic block diagram of another embodiment of a backlight control module in accordance with the present invention; and

FIG. 8 is a schematic block diagram of another embodiment of the SOC coupled to an off-chip variable supply voltage source and an off-chip display in accordance with the present invention.

### DETAILED DESCRIPTION OF THE INVENTION

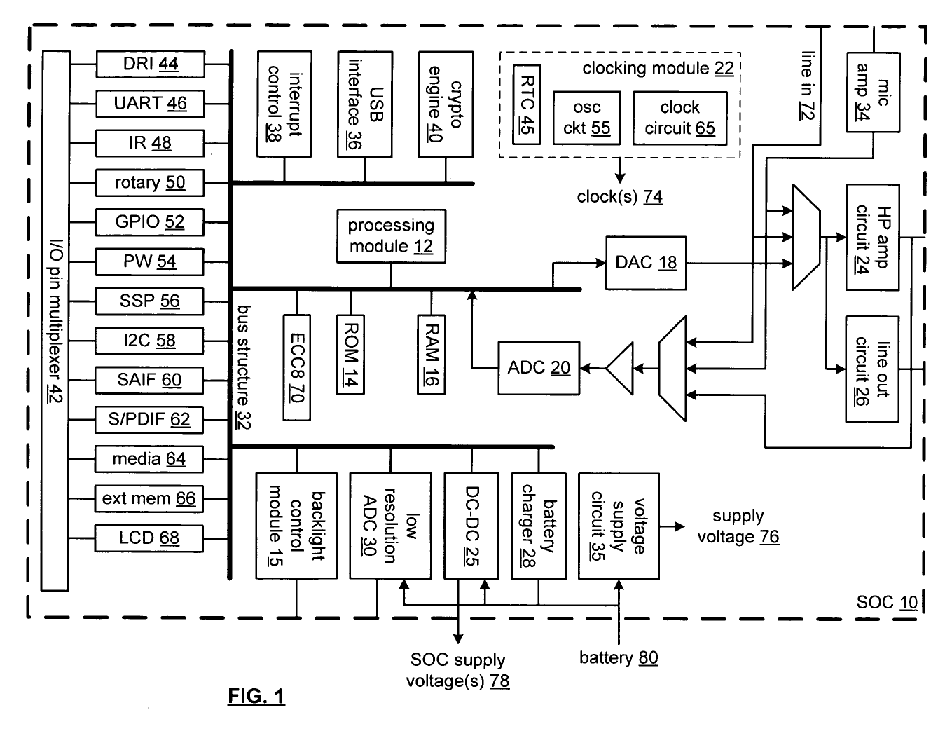

FIG. 1 is a schematic block diagram of a system on a chip (SOC) 10 that may be used in a portable entertainment device (e.g., an MP3 player, an advanced MP3 player (i.e., music, photos, and video playback), cellular telephones, personal computers, laptop computers, and/or personal digital assistants. The SOC 10 includes at least some of a processing module 12, read only memory (ROM) 14, a backlight control module 25, random access memory (RAM) 16, a digital to analog conversion (DAC) module 18, an analog to digital conversion (ADC) module 20, a clocking module 22, a headphone (HP) amplifier circuit 24, a DC-DC converter 25, a line out circuit 26, a battery charger 28, a low resolution ADC 30, a bus structure 32, a microphone amplifier 34, a universal serial bus (USB) interface 36, an interrupt controller 38, a crypto engine 40, an input/output pin multiplexer 42, a plurality of interface modules 44-68, an ECC8 module 70, and a line in pin 72.

The clocking module 22 includes one or more of a real time clock (RTC) module 45, an oscillation circuit 55, and a clock circuit 65. In one embodiment, the oscillation circuit 55 is coupled to an off-chip crystal and produces therefrom an oscillation. The clock circuit 65 may use the oscillation as a reference oscillation to produce one or more clock signals 74 that are used by at least some of the other blocks of the SOC. The RTC module 45 provides timing functions such as a second counter, a programmable millisecond interrupt, an alarm interrupt and power-up facility, a watchdog reset, and storage and access to persistent registers.

The plurality of interface modules 44-68 includes at least some of a digital recording interface (DRI) interface 44, a universal asynchronous receiver-transmitter (UART) interface 46, an infrared (IR) interface 48 (e.g., IrDA), a rotary controller 50, a general purpose input/output (GPIO) interface 52, a pulse width (PW) interface 54, a security software provider (SSP) interface 56, an I2C interface 58, a serial audio input (SAIF) transmit and/or receive interface 60, a Sony Philips Digital Interface (SPDIF) 62, a media interface 64, an external memory interface 66, and a liquid crystal display (LCD) interface 68. In an application, the DRI interface 44 may be used to interface with a stereo FM (frequency modulated) receiver; the UART interface 46 may be used to interface with a host device and/or be used to debug the SOC; the IR interface 48 may be used to provide peer-to-peer IR communication; the pulse width interface 54 may be used in connection with the backlight control module 15 to control backlighting of a display and/or to provide an output beep; the SSP interface 56 may be used to interface with off-chip devices having one or more of an multimedia card (MMC) interface, a scientific data (SD) interface, a secure digital input/output (SDIO) interface, a consumer electronics-AT attachments (CE-ATA) interface, a Triflash interface, a serial peripheral interface (SPI), and a master software (MS) interface; the S/PDIF interface 62 may be used to interface with off-chip devices having an S/PDIF transmit and/or receive interface; the media interface 64 may be used to interface with a hard drive, NAND flash or compact flash to transceiver digitized audio, video, image, text, and/or graphics data; the external memory interface 66 may be used to interface with an SDRAM, a NOR memory, and/or a dual data rate (DDR) memory device; and the LCD interface 68 may be used to interface with a display.

The DC-DC converter 25, which may be a buck and/or boost converter, generates one or more SOC supply voltages 78 from a battery 80. For example, the DC-DC converter 25 may produce a 1.2 V supply voltage, a 1.8 V supply voltage, and a 3.3 V supply voltage. Note that the DC-DC converter 25 may use a single off-chip inductor to produce the SOC supply voltages 78. Further note that when the SOC 10 is receiving power from a source other than the battery 80 (e.g., 5 V from a USB connection), the DC-DC converter 25 may generate one or more the SOC voltages from the alternative power source. When the alternate power source is available, the battery charger 28 may be enabled to charge the battery 80.

In operation, the processing module 12 coordinates the recording, playback, and/or file management of multimedia data (e.g., voice, audio, text, data, graphics, images, and/or video). The processing module 12 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module 12 may have an associated memory and/or memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that when the processing module 12 implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Further note that, the memory element stores, and the processing module executes, hard coded and/or operational instructions corresponding to at least some of the steps and/or functions illustrated in FIGS. 1-5.

In a playback mode of operation, the processing module 12 coordinates the retrieval of multimedia data from off-chip memory via one of the interfaces 44, 48, 52, 56, 60, 62, 64, and/or 66. The retrieved data is routed within the SOC via the bus structure 32, which may include a peripheral bus and an advanced high-performance bus (AHB). If the retrieved data is encrypted, the crypto engine 40 decrypts the retrieved data to produce decrypted retrieved data. If the decrypted retrieved data is encoded (e.g., is an MP3 file, WMA file, MPEG file, JPEG file, etc.), the processing module 12 coordinates and/or performs the decoding of the retrieved data to produce digitized data. An audio component of the digitized data is provided to the DAC module 18, which may include one or more digital to analog converters. The DAC 18 converts the digitized audio component into analog audio signals. The headphone amplifier circuit 24 and the line out circuit 26 provide the analog audio signals off-chip. A video or image component of the digitized data is provided to the LCD interface for display.

In an audio record mode, the processing module 12 coordinates the storage of analog audio input signals received via the microphone amplifier 34 or the line input 72. In this mode, the ADC module 20 converts the analog audio input signals into digitized audio signals which are then placed on the bus structure. In one embodiment, the processing module 12 may coordinate the storage of the digitized audio signals in an off-chip memory device. In another embodiment, the processing module 12 coordinates and/or performs encoding (e.g., MP3, WMA, etc.) of the digitized audio signals to produce encoded audio signals, which are subsequently stored in off-chip memory.

In a file management mode, the processing module 12 coordinates the transferring, editing, and/or deleting of files (e.g., MP3 files, WMA files, MPEG files, JPEG files, and/or any other type of music, video and/or still image files) with a host device via the USB interface 36. For example, the host device (e.g., a laptop or PC) may download a music file to the portable entertainment device that includes the SOC 10 via the USB interface 36. The USB interface 36 places the music file on the bus structure 32 and it is routed to the desired destination under the control of the processing module 12. Note that the interrupt control module 38 facilitates the various modes of operation by processing interrupts, providing timers, and direct memory access.

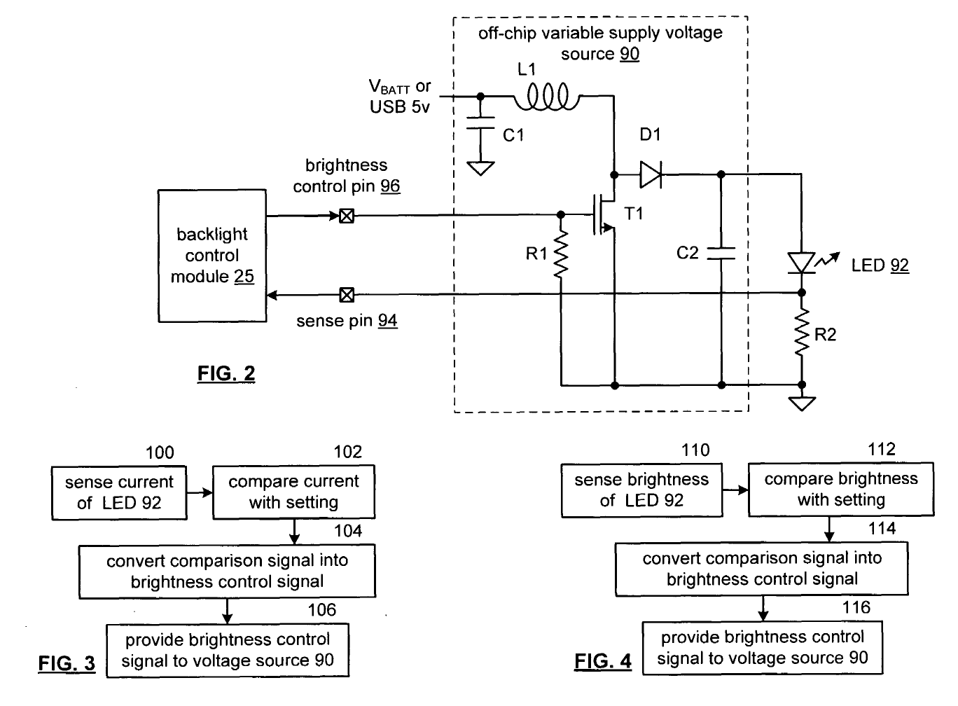

FIG. 2 is a schematic block diagram of an embodiment of a backlight control module 25 coupled to an off-chip variable supply voltage source 90 via a brightness control pin 96 and a sense pin 94. In this embodiment, the off-chip variable supply voltage source 90 includes an input capacitor C1, an inductor L1, a switching transistor T1, a resistor R1, a diode D1, and an output capacitor C2 coupled in a boost converter topology. The output capacitor C2 provides the variable supply voltage provided to the off-chip light emitting diode (LED) 92. Note that, while the off-chip variable supply voltage source 90 is shown as a boost converter, other converter topologies may be used such as a buck converter, half bridge converter, etc.

In alternative embodiments, capacitor C2, diode D1, and/or resistor R1 may be omitted. In such embodiments, the off-chip variable supply voltage source 90 is outputting a controlled pulsed current instead of a voltage.

In the embodiment of FIG. 2, the current of the backlight LED 92 is sensed via resistor R2. The voltage across R2, which is indicative of the current (V=I*R2), is provided to the backlight control module 25 via sense pin 94. The backlight control module 25 may perform the method of FIG. 3 to generate a brightness control signal. The method begins at step 100 where the backlight control module 25 senses the current of the LED 92. This may be done via resistor R2 or by sensing the voltage drop across the LED 92 and equating the voltage drop to a current based on an I-V curve of the LED.

The method then proceeds to step 102 where the backlight control module 25 compares a representation of the current (i.e., a measure of the current, the voltage drop across R2, or the voltage drop across the diode) with a representation of a backlight setting to produce a comparison signal. The representation of the backlight setting may be a voltage, current, or digital signal established based a user setting of an off-chip switch or other off-chip brightness setting input mechanism (e.g., touch screen, keypad, etc).

The method then proceeds to step 104 where the backlight control module 25 converts the comparison signal into a brightness control signal. The generation of the brightness control signal is dependent on the off-chip variable supply voltage source 90. For example, if the supply voltage source 90 is a pulse width modulated boost converter, then the brightness control signal would be a pulse width modulated signal. As another example, if the supply voltage source 90 is a frequency modulated boost converter, then the brightness control signal would be a frequency modulated signal. As yet another example, the brightness control signal could be a combination of pulse and frequency modulation. As yet a further example, the supply voltage source 90 may be a linear regulator, where the brightness control signal is a linear regulation signal. As an even further example, the supply voltage source 90 may produce a plurality of fixed output voltages where the brightness control signal selectively couples one of the output voltages to the LED 92.

The method then proceeds to step 106 where the backlight control module 25 provides the brightness control signal to the off-chip variable supply voltage source 90 via the brightness control pin 96. Note that the PW interface 54 may be included in, or associated with, the backlight control module 25 to provide the backlight control signal to the supply voltage source 90. In one embodiment, the PW interface 54 generates a pulse width control signal for the supply voltage source 90.

FIG. 4 is a logic diagram of another method for controlling backlighting that begins at step 110 where the backlight control module 25 senses brightness of an off-chip light emitting diode (LED) 92 that provides backlighting of a display. The sensing of the brightness of the LED 92 may be done as previously discussed with references to FIGS. 2 and 3. Alternatively, the brightness may be sensed by a light sensing diode, which may be on-chip or off-chip. The light sensing diode, which is positioned proximal to the LED 92, generates a voltage corresponding to the level of light received via the LED 92. The voltage corresponds to the sensed brightness.

The method then proceeds to step 112 where the brightness control module 25 compares a representation (e.g., voltage, current, digital signal representing voltage or current) of the brightness with a representation of a backlight setting to produce a comparison signal. The representation of the backlight setting may be a voltage, current, or digital signal established based on a user setting of an off-chip switch or other off-chip brightness setting input mechanism (e.g., touch screen, keypad, etc).

The method then proceeds to step 114 where the backlight control module 25 converts the comparison signal into a brightness control signal. This may be done as previously discussed with reference to step 104 of FIG. 3. The method then proceeds to step 116 where the backlight control module 25 provides the brightness control signal off-chip to adjust brightness the off-chip LED in accordance with the backlight setting. This may be done as previously discussed with reference to step 106 of FIG. 3.

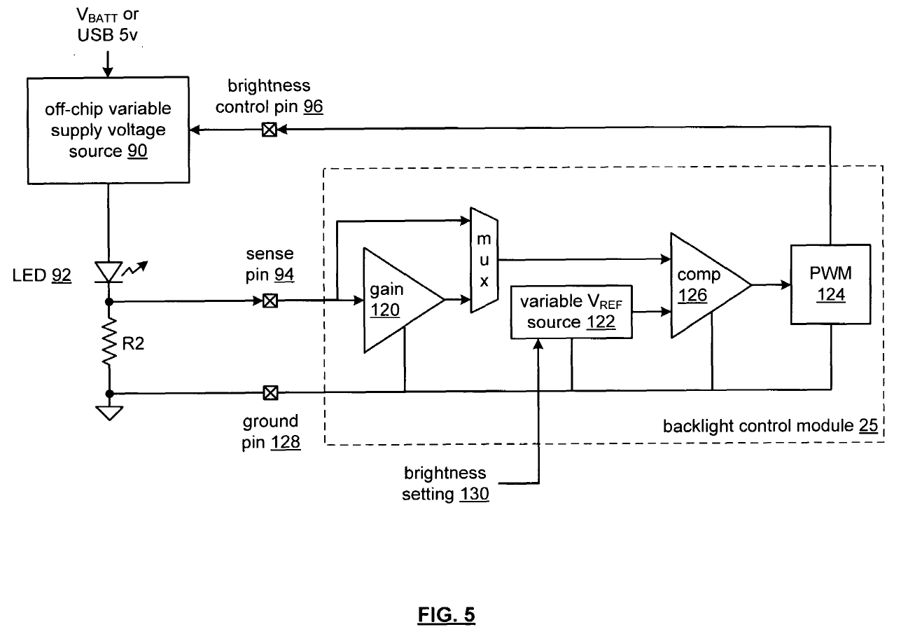

FIG. 5 is a schematic block diagram of another embodiment of a backlight control module 25 coupled to an off-chip variable supply voltage source 90. In this embodiment, the backlight control module 25 includes a gain module 120, a multiplexer (mux), a variable voltage reference source 122, a comparator 126, and a pulse width modulator 124, which may be included in the PW interface 54.

In this embodiment, the gain module 120 is coupled to amplify the representation of the current to produce an amplified current sense signal. In one embodiment, the representation of the current is produced by an off-chip resistor R2 in series with the off-chip LED 92. The multiplexer is coupled to output the amplified current sense signal or the representation of the current based on a multiplexer control signal to produce a selected current sense signal. Note that in one embodiment, the multiplexer may be omitted such that the amplified current sense signal is provided to the comparator 126. Further note that in another embodiment, the gain module 120 and the multiplexer may be omitted such that the representation of the current is provided to the comparator 126.

The variable voltage reference source 122 is coupled to produce a reference voltage (V_{REF}) based on the backlight setting 130 to produce the representation of the backlight setting. In this embodiment, the reference voltage is a representation of the backlight setting, which may be a voltage, current, or digital signal that is based on a user setting of an off-chip switch or other off-chip brightness setting input mechanism (e.g., touch screen, keypad, etc). Alternatively, the processing module 12 may generate the brightness setting based on a user input, measured ambient light, and/or other some selecting criteria.

The comparator 126 compares the reference voltage with the amplified current sense signal to produce the comparison signal. The pulse width modulator 124 produces a pulse width modulated (PWM) signal as the brightness control signal based on the comparison signal, wherein the off-chip variable supply voltage source is a DC-DC converter. Note that a common ground pin 128 is used for the off-chip backlighting LED and current sense resistor R2 and the backlight control module 25. Further note that, if the off-chip variable supply voltage source 90 is controlled based on a frequency modulated signal or some other type of control signal, then the PWM 124 would be replaced with the appropriate module to generate the proper power supply control signal. In another embodiment, the PWM 124 gates and ungates the PWM signal as the brightness control signal.

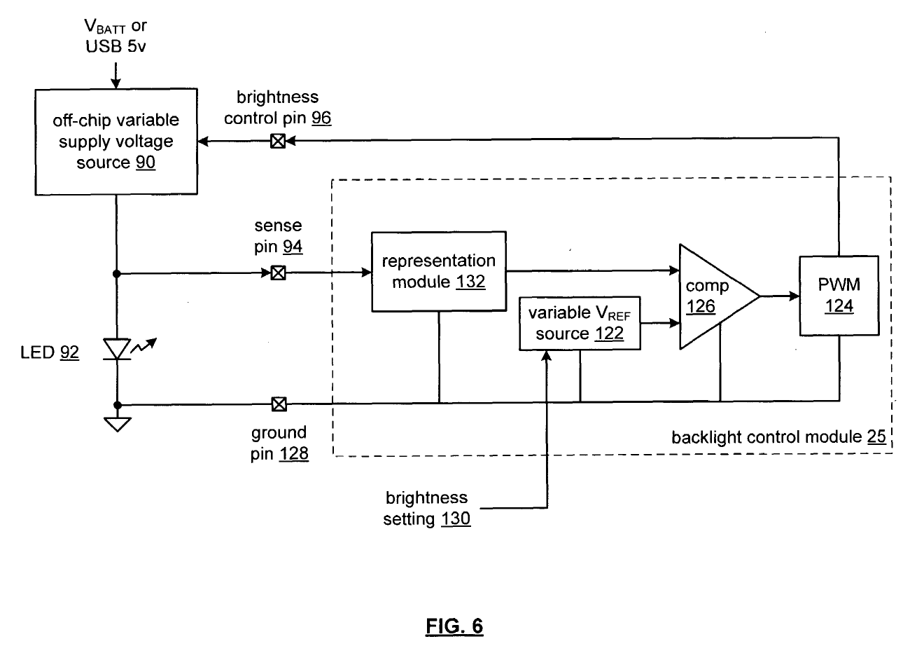

FIG. 6 is a schematic block diagram of another embodiment of a backlight control module 25 coupled to an off-chip variable supply voltage source 90. In this embodiment, the backlight control module 25 includes a representation module 132, a variable voltage reference source 122, a comparator 126, and a pulse width modulator 124, which may be included in the PW interface 54.

The representation module 132 receives a voltage drop of the LED 92, which it converts into a representation of current of the LED and/or into a representation of voltage of the LED. The current conversion may be done via lookup table based on an I-V curve of the LED 92, a state machine, a logic circuit, and/or an amplifier circuit. In an embodiment where the representation module 132 produces the voltage representation, the representation module 132 includes an off-chip resistive divider network that divides the LED voltage before providing it to the sense pin 94. The remainder of the backlight control module 25 processes the divided LED voltage to produce the brightness control signal.

In the embodiment of FIG. 6, the variable voltage reference source 122 is coupled to produce a reference voltage (V_{REF}) based on the backlight setting 130 to produce the representation of the backlight setting. In this embodiment, the reference voltage is a representation of the backlight setting, which may be a voltage, current, or digital signal that is based on a user setting of an off-chip switch or other off-chip brightness setting input mechanism (e.g., touch screen, keypad, etc). Alternatively, the processing module 12 may generate the brightness setting based on a user input, measured ambient light, and/or other some selecting criteria.

The comparator 126 compares the reference voltage with the amplified current sense signal to produce the comparison signal. The pulse width modulator 124 produces a pulse width modulated (PWM) signal as the brightness control signal based on the comparison signal, wherein the off-chip variable supply voltage source is a DC-DC converter. Note that a common ground pin 128 is used for the off-chip backlighting LED and current sense resistor R2 and the backlight control module 25. Further note that, if the off-chip variable supply voltage source 90 is controlled based on a frequency modulated signal or some other type of control signal, then the PWM 124 would be replaced with the appropriate module to generate the proper power supply control signal. In another embodiment, the PWM 124 gates and ungates the PWM signal as the brightness control signal.

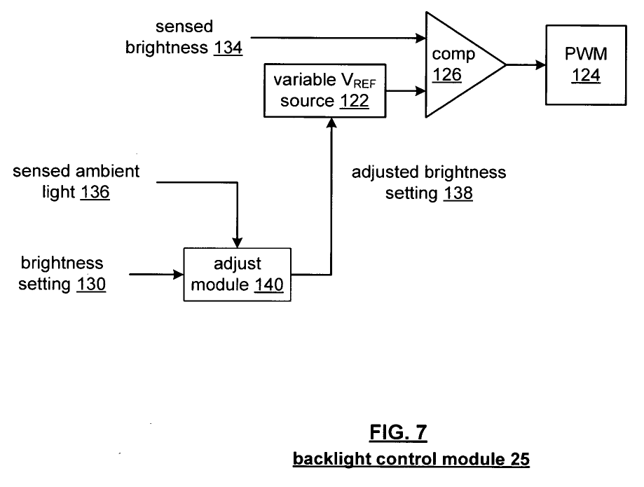

FIG. 7 is a schematic block diagram of another embodiment of a backlight control module 25 that includes an adjust module 140 (e.g., a multiplier, an adder, a subtraction unit, etc.), the variable reference voltage source 122, the comparator 126 and the pulse width modulator 124. In this embodiment, sensed ambient light 136 is multiplied with the brightness setting 130 to produce an adjusted brightness setting 138. The ambient light 136 may correspond to a voltage produced by a light receiving diode that senses the ambient light of the portable entertainment device incorporating the SOC 10. In this manner, the brightness setting 130 may be automatically adjusted based on the ambient light (e.g., in a bright area, need less backlighting than in a dark area). Alternatively, the brightness setting 130 may be automatically generated from the sensed ambient light 130, such that the adjust module 140 is not needed.

The variable voltage reference source 122 is coupled to produce a reference voltage (V_{REF}) based on the adjusted backlight setting 138 to produce the representation of the backlight setting.

The comparator 126 compares the reference voltage with the sensed brightness 134 (e.g., LED current, a representation of the current, a voltage drop across the LED, light receiving diode voltage, etc.) to produce the comparison signal. The pulse width modulator 124 produces a pulse width modulated (PWM) signal as the brightness control signal based on the comparison signal, wherein the off-chip variable supply voltage source is a DC-DC converter. Note that, if the off-chip variable supply voltage source 90 is controlled based on a frequency modulated signal or some other type of control signal, then the PWM 124 would be replaced with the appropriate module to generate the proper power supply control signal. In another embodiment, the PWM 124 gates and ungates the PWM signal as the brightness control signal.

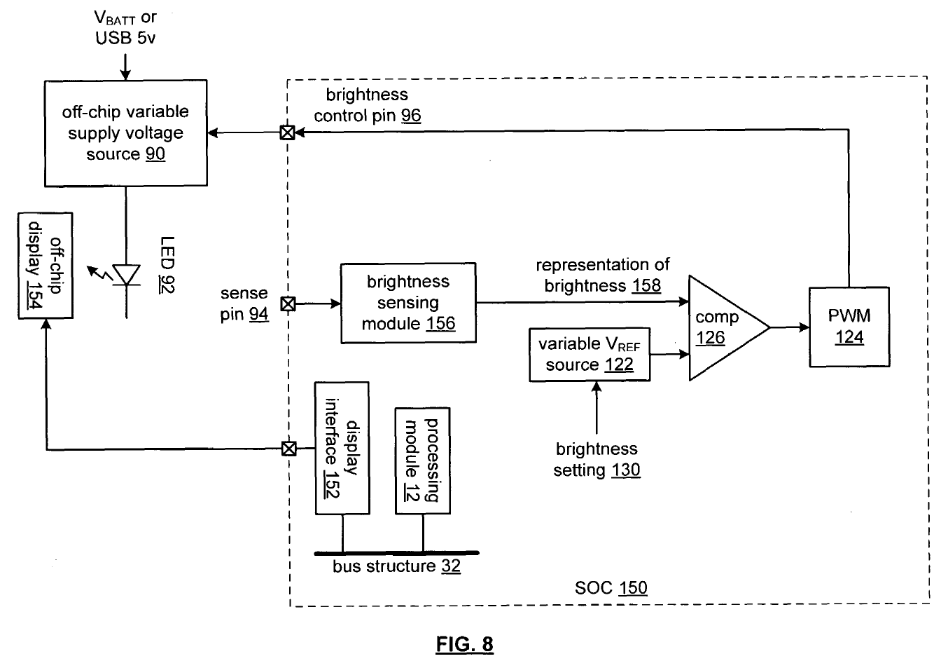

FIG. 8 is a schematic block diagram of another embodiment of an SOC 150 coupled to an off-chip variable supply voltage source 90 and to an off-chip display 154. In this embodiment, the SOC 150 includes a display interface 152, which may include LCD interface 68, the processing module 12, the bus structure 32, a brightness sensing module 156, the variable voltage reference source 122, the comparator 126, and the pulse width modulator 124.

In this embodiment, the display interface 152 provides display data (e.g., text, video, images, etc.) to the off-chip display 154, which may be an LCD. The off-chip variable supply voltage source 90 provides a supply voltage to the LED 92, which provides backlighting for the display 154. As such, the brightness of the display 154 is established based on the voltage applied to LED 92.

To provide closed loop and tight regulation of the LED's brightness, a backlight sense integrated circuit (IC) pin 94 receives an indication of the brightness of the LED and provides it to a brightness sensing module 156. The brightness sensing module 156 generates a representation of brightness 158 of a light emitting diode (LED) 92. The representation of brightness 158 may be from a current sense resistor, a voltage drop across the LED, and/or sensed light emitted from the LED 92.

The variable voltage reference source 122 is coupled to produce a reference voltage (V_{REF}) based on the adjusted backlight setting 138 to produce the representation of the backlight setting.

The comparator 126 compares the reference voltage with the representation of brightness 158 (e.g., LED current, a representation of the current, a voltage drop across the LED, light receiving diode voltage, etc.) to produce the comparison signal. The pulse width modulator 124 produces a pulse width modulated (PWM) signal as the brightness control signal based on the comparison signal, wherein the off-chip variable supply voltage source is a DC-DC converter. Note that, if the off-chip variable supply voltage source 90 is controlled based on a frequency modulated signal or some other type of control signal, then the PWM 124 would be replaced with the appropriate module to generate the proper power supply control signal.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A system on a chip (SOC) comprises:
a bus structure;
a processing module coupled to the bus structure;
read only memory (ROM) coupled to the bus structure;
random access memory (RAM) coupled to the bus structure;
a display interface coupled to the bus structure;
an external memory interface coupled to the bus structure;
a digital to analog conversion (DAC) module coupled to the bus structure, wherein the digital to analog converter produces an analog audio signal;
an analog to digital conversion (ADC) module coupled to the bus structure;
a headphone amplifier circuit coupled to amplify the analog audio signal; and
a backlight control module coupled to:
sense current of an off-chip light emitting diode (LED) that provides backlighting of a display;
compare a representation of the current with a representation of a backlight setting to produce a comparison signal;
convert the comparison signal into a brightness control signal; and
provide the brightness control signal to an off-chip variable supply voltage source that provides power to the off-chip LED.

2. The SOC of claim 1, wherein the backlight control module comprises:
a gain module coupled to amplify the representation of the current to produce an amplified current sense signal, wherein the representation of the current is produced by an off-chip resistor in series with the off-chip LED;
a variable voltage reference source coupled to produce a reference voltage based on the backlight setting to produce the representation of the backlight setting;
a comparator coupled to compare the reference voltage with the amplified current sense signal to produce the comparison signal; and
a pulse width modulator coupled to produce a pulse width modulated (PWM) signal as the brightness control signal based on the comparison signal, wherein the off-chip variable supply voltage source is a DC-DC converter.

3. The SOC of claim 2 further comprises:
a current sense input integrated circuit (IC) pin for facilitating a connection between the off-chip LED and the gain module; and
a PWM IC pin for facilitating a connection between the DC-DC converter and the pulse width modulator.

4. The SOC of claim 1, wherein the backlight control module comprises:
a gain module coupled to amplify the representation of the current to produce an amplified current sense signal;
a multiplexer coupled to output the amplified current sense signal or the representation of the current based on a multiplexer control signal to produce a selected current sense signal;
a variable voltage reference source coupled to produce a reference voltage based on the backlight setting to produce the representation of the backlight setting;
a comparator coupled to compare the reference voltage with the selected current sense signal to produce the comparison signal; and
a pulse width modulator coupled to produce a pulse width modulated (PWM) signal as the brightness control signal based on the comparison signal, wherein the off-chip variable supply voltage source is a DC-DC converter.

5. The SOC of claim 1, wherein the backlight control module comprises:
a representation module coupled to convert a voltage drop across the off-chip LED into the representation of the current, wherein the representation module is coupled to the off-chip LED;
a variable voltage reference source coupled to produce a reference voltage based on the backlight setting to produce the representation of the backlight setting;
a comparator coupled to compare the reference voltage with the representation of the current to produce the comparison signal; and
a pulse width modulator coupled to produce a pulse width modulated (PWM) signal as the brightness control signal based on the comparison signal, wherein the off-chip variable supply voltage source is a DC-DC converter.

6. The SOC of claim 1, wherein the backlight control module further comprises:
an input to receive a representation of ambient light, wherein the backlight control module adjusts the representation of the backlight setting based on the representation of ambient light.

7. A system on a chip (SOC) comprises:
a bus structure;
a processing module coupled to the bus structure;
read only memory (ROM) coupled to the bus structure;
random access memory (RAM) coupled to the bus structure;
a display interface coupled to the bus structure;
an external memory interface coupled to the bus structure;
a digital to analog conversion (DAC) module coupled to the bus structure, wherein the digital to analog converter produces an analog audio signal;
an analog to digital conversion (ADC) module coupled to the bus structure;
a headphone amplifier circuit coupled to amplify the analog audio signal; and
a backlight control module coupled to:
sense brightness of an off-chip light emitting diode (LED) that provides backlighting of a display;
compare a representation of the brightness with a representation of a backlight setting to produce a comparison signal;
convert the comparison signal into a brightness control signal; and
provide the brightness control signal off-chip to adjust brightness the off-chip LED in accordance with the backlight setting.

8. The SOC of claim 7, wherein the sensing of the brightness of the off-chip LED comprises:
receiving a representation of light emitted by the off-chip LED; and
converting the representation of the light into a voltage.

9. The SOC of claim 8, wherein the receiving the representation comprises at least one of:
receiving a voltage drop of an off-chip light receiving diode that is proximal to the off-chip LED; and
receiving, via an on-chip light receiving diode, the light emitted by the off-chip LED.

10. The SOC of claim 7 further comprises:
the sensing of the brightness of the off-chip LED includes receiving a representation of current of the off-chip LED, wherein the backlight control module includes:
a gain module coupled to amplify the representation of the current to produce an amplified current sense signal, wherein the representation of the current is produced by an off-chip resistor in series with the off-chip LED;
a variable voltage reference source coupled to produce a reference voltage based on the backlight setting to produce the representation of the backlight setting;
a comparator coupled to compare the reference voltage with the amplified current sense signal to produce the comparison signal; and
a gating control circuit to gate and ungate a pulse width modulated (PWM) signal as the brightness control signal based on the comparison signal, wherein the off-chip variable supply voltage source is a DC-DC converter.

11. A system on a chip (SOC) comprises:
a processing module coupled to coordinate display of data;
a display interface coupled to provide the data to an off-chip display;
a backlight sense integrated circuit (IC) pin coupled to receive a representation of brightness of a light emitting diode (LED) backlight of the off-chip display;
a comparator coupled to compare the representation of brightness with a brightness setting to produce a comparison signal;
a control signal generating module coupled to convert the comparison signal into a brightness control signal; and
a brightness control signal IC pin coupled to provide the brightness control signal to an off-chip variable supply voltage source that provides power to the LED.

12. The SOC of claim 11 further comprises:
a gain module coupled to amplify a representation of current of the LED to produce an amplified current sense signal, wherein the representation of the current corresponds to the representation of brightness; and
a variable voltage reference source coupled to produce a reference voltage based on the backlight setting to produce a representation of the backlight setting, wherein the comparator compares the reference voltage with the amplified current sense signal to produce the comparison signal, and wherein the control signal generating module produces a modulation signal as the brightness control signal based on the comparison signal, wherein the off-chip variable supply voltage source is a DC-DC converter.

13. The SOC of claim 11 further comprises:
a gain module coupled to amplify a representation of current of the LED to produce an amplified current sense signal, wherein the representation of the current corresponds to the representation of brightness;
a multiplexer coupled to output the amplified current sense signal or the representation of the current based on a multiplexer control signal to produce a selected current sense signal; and
a variable voltage reference source coupled to produce a reference voltage based on the backlight setting to produce a representation of the backlight setting, wherein the comparator compares the reference voltage with the selected current sense signal to produce the comparison signal, and wherein the control signal generating module produces a modulation signal as the brightness control signal based on the comparison signal, wherein the off-chip variable supply voltage source is a DC-DC converter.

14. The SOC of claim 11 further comprises:
a representation module coupled to convert a voltage drop across the LED into a representation of current, wherein the representation module is coupled to the off-chip LED and wherein the representation of the current corresponds to the representation of brightness; and
a variable voltage reference source coupled to produce a reference voltage based on the backlight setting to produce a representation of the backlight setting, wherein the comparator compares the reference voltage with the representation of current to produce the comparison signal, and wherein the control signal generating module produces a modulation signal as the brightness control signal based on the comparison signal, wherein the off-chip variable supply voltage source is a DC-DC converter.

15. The SOC of claim 11 further comprises:
an input to receive a representation of ambient light, wherein the control signal generating module adjusts the backlight setting based on the representation of ambient light.
